(19) United States
(12) Patent Application Publication
(10) Pub. No.: US 2003/0061106 A1
(43) Pub. Date: Mar. 27, 2003

(54) Data transfer or transfer of data using wireless mobile phone and any other wireless mobile devices

(76) Inventor: Sunday Orhomuru, Atlanta, GA (US)

Correspondence Address: Sunday Orhomuru, 177 Pinetree Circle, Decatur, GA, 30032, US

(21) Appl. No.: 09/862,789

(22) Filed: Sep. 21, 2001

(51) Int. Cl. G06F 17/60

(52) U.S. Cl. 705/26; 709/218

(57) ABSTRACT

Data transfer or transfer of data using wireless mobile phone and any other wireless devices, that is able to access and update any type of data files or database using wireless mobile phone and other wireless devices and also able to access and update the same data files or database files online or offline or both online and offline using computer on a very secure environment with data integrity.

### BACKGROUND OF THE INVENTION

My name is Sunday Orhomuru, I am a citizen of USA. I have Bs in business from Alabama A&M University and do computer science in graduate school in the same university. During my graduate study I work in the school as graduate assistance. I love programming, I can say if not the best, I was one of the best in school. When I leave school I can't find a job because I have an accent, those that try to offer me something always want to pay me the lowest salary. As a result I decide to do something else for the time been in hope of trying to save some money and one day to start my own business. I decide to drive truck and run nation wide, in 1999 when the Internet was on it pick in USA some of my friends encourage me to try and start a small web site designing company. Early 2000 I decide to get a local truck driving job so that I will have time to start my business. To start I decide to do some research first on what are the best development application package I can use to develop the best web site, knowing that there are lot of well establish company doing the same thing. It was during this time that I come across this, “TRANSFER OF DATA USING WIRELESS MOBILE PHONE AND OTHER WIRELESS MOBILE DEVICES or some time call DATA TRANSFER USING WIRELESS MOBILE PHONE AND ANY OTHER WIRELESS MOBILE DEVICES”

### BRIEF SUMMARY OF THE INVENTION

In 1997 the term WAP “Wireless Application Protocol” hit the headlines all over the world. The arrival of WAP coincided with a period of great interest in the wireless world, both in consumer and industry markets.

WAP is a communications protocol and application environment for the deployment of information resources, advanced telephony services, and Internet access from mobile devices.

By the end of 2000 many companies have came out with some hand held devices use to access the internet. Devices like Palm handheld computers, Pocket PC and some wireless mobile phones to access the internet.

The palm handheld computers and pocket PC access the internet by connecting those devices to a computer using a cable then download those files from the internet to the devices through the computer and the connecting cable to the devices.

Those wireless mobile phone are able to access the internet sent and receive emails. Some developers are able to develop some applications that allow those wireless mobile phone to access some limited text files from the internet.

In early 2000 I develop a data driving web site. A data driving web site is a web site that is connected directly to either a personal , business or corporate database files. And most of the text on each pages is generated from the database. At this time there is a lot of talks about accessing the internet with wireless mobile phone and other wireless devices. Then it come to my mind that if I can make those personal, business or corporate data files and database files accessible to the internet in a secure environment I suppose to be able to develop an application that will make it possible for a wireless mobile phone and other wireless mobile devices to access those data files. That is the transfer of that data files between personal, business or corporate computer data files and wireless mobile phone and other wireless mobile devices in wireless environment with the help of the internet without any cable connection. It work I get 100% perfect result.

In other to be sure of my finding I develop more deferent applications on deferent platforms using deferent application development packages.

ASP by Microsoft on Microsoft platform

JSP by Sun Micro System on Sun, Unix and Linux Platforms.

ColdFusion by Allaire Corporation on Microsoft, Sun, Unix and Linux platforms.

All the three application development packages work 100% perfect.

Since the processes in using the three to create application for transfer of data using wireless devices are similar I am going to describe one of them with diagram. I am going to use ASP by Microsoft.

Data transfer or transfer of data using wireless mobile phone and any other wireless mobile devices is a great new technology. It is useful to the general public, business people, workers, politician, students etc. With this people will be able to access and update any data files or database files in their personal, business and corporate computers using wireless mobile phone and any other wireless mobile devices from anywhere, anytime, anyplace.

The more complex component you can create, the more powerful application for data transfer using wireless mobile phone and any other wireless mobile devices you will create e.g. Some of the applications I was able to develop are listed below.

You can perform any of those functions below using your wireless mobile phone and any wireless mobile devices form anywhere, anyplace, anytime.

Personal

Access, search, post, update and delete any of your directory data files in your personal computer

Access, search, post, update and delete any of your event calendar data files in your personal computer

Access, search, post, update and delete any of your personal data files in your personal computer

Access, search, post, update and delete any of your personal account data files in your personal computer

Business

Access, search, post, update and delete any of your data files in your business or corporate computer

Access, search, post, update and delete any of your employees data file in your business or corporate computer

Access, search, post, update and delete any of your customers data file in your business or corporate computer

Access, search, post, update and delete any of your business data files in your business or corporate computer

Banks

Your customers will be able to access their account using their wireless mobile phone and any other wireless mobile devices from anywhere, anytime.

Brokers

Your customers will be able to have access to a real life quote from the company data files from anywhere anytime without affecting the data securities and this will give your customers more freedom and controls over their portfolios.

E-COMMERCE SOLUTION FOR WIRELESS MOBILE PHONE AND ANY OTHER WIRELESS MOBILE DEVICES is the most important application I was able to develop. This system consist of WAP Shopping Site with catalog System that allows for the displaying, browsing, and searching of products, WAP shopping cart that allows visitors to add, view, and delete items ordered and allows visitors to check out. When visitors check out they are presented with a secure page to supply their personal information. [Wireless Mobile Phone and other Wireless Devices Shopping Cart] with built in 24 Hour a Day, 7 Days a Week Support System providing your customers with feedbacks and communications. This system is 100% compatible to computers data driving catalog and shopping cart system, using database like Access Database, SQL Server etc. Very easy to use and manage.

Advertise Sites

Calculator/Converters e.g.

Geometry

Area of Circle

Volume of Cone

Area of Square

Volume of Cube

Area of Rectangle

Volume of Rectangle

Area of Triangle

Volume of Triangle

Measurement

Inches to Centimeter

Centimeter to Inches

Yards to Meters

Meters to Yards

Miles to Kilometers

Kilometers to Miles

Weight-Volumes

Ounce to Grams

Grams to Ounce

Pound to Kilogram

Kilogram to Pound

Gallons to Liters

Liters to Gallons

Temperature

Fahrenheit to Celsius

Celsius to Fahrenheit

Binary Oct Hex

From Binary

To Binary

From Oct

To Oct

From Hex

To Hex

General Usage

Global Time Keeper

Truckers

Find Loads

Find Trucks

Post Your Loads

Post Your Trucks

And much more

The use for this new technology is unlimited.

With this new technology you can use your wireless mobile phone and any other wireless mobile devices to do almost anything you can do using your computer.

### DETAILED DESCRIPTION OF THE INVENTION

ASP Active Server Pages allow us to combine standard MIME type HTML elements like tables, text, and titles with scripting language elements like database fields, date/time information, and personal customization to produce a Web page that is dynamically generated every time the page is requested from a browser. The browser request the Active Server Page, which is then processed by the Internet Information Server IIS. IIS then runs your VBScript, turning it into standard HTML tags and text. The resulting pages contains none of your code and is viewable by virtually any browser like Internet Explorer, Netscape Navigator, AOL's browser. And if you tell your Internet Information Server, IIS to use the MIME type for WML (text/vnd.wap.wml) and if you create add on component for WAP, will be able to view and access by wireless mobile phone and any wireless mobile devices.

HTML pages can be turned into Active Server Pages simply by changing their file extensions to asp. If you then point your browser at one of the pages you should notice nothing different at all. Without adding any extra ASP code there will be almost no effect regarding how the page looks or functions.

The principle is exactly the same with WML. However in addition to changing the extension of WML files to .asp there is one more thing to do. By default, IIS will forward the contents of an ASP file to the browser using the MIME type for HTML, which will be rejected by a WAP device. So, we just need to tell the server to use the MIME type for WML.

Sending dynamic web content to your browser involves you requesting the page, IIS retrieving and interpreting the page, and the resulting HTML or WML being sent to your browser. The diagrams shows this process.

First you type in a request to visit the site like http://whatever.com/whatever.asp or click on a link that sends you to that page. Note that the name of the page ends in asp, which is referred to as a file extension. The request for the page, as shown in step 2, routes its way to the Internet Information Server IIS.

In step 3, IIS retrieves the requested files and note that the request has files extension of .asp which tells IIS that this is a dynamic page containing script that it must interpret. IIS compile the ASP code, which can require IIS to launch other components like database SQL Server, Access database, Oracle database, browser capability, etc and your own created components.

Launching these components is where you really see the power of ASP. Components allow you to read from database any contents, customers, files, workers files, etc. Also to check what type of browser the request have before displaying the files.

All of this script and component code is converted into standard HTML or WML that is sent back out through the Internet to your browser in step 5. In the final step, your browser receives either HTML or WML depending on what type of device you tell IIS that you are using.

1 What I claim as my invention is: Systems or applications that are able to access, search, post, update and delete any type of data files or database using wireless mobile phone and any other wireless mobile devices and also able to access, search, post, update and delete the same data files or database files online or offline or both online and offline using computer on a very secure environment with data integrity.

2 What I claim as my invention is: Data transfer or transfer of data using wireless mobile phone and any other wireless mobile devices, that are able to access, search, post, update and delete any type of data files or database using wireless mobile phone and any other wireless mobile devices and also able to access, search, post, update and delete the same data files or database files online or offline or both online and offline using computer on a very secure environment with data integrity.

3 E-COMMERCE SOLUTION FOR WIRELESS MOBILE PHONE AND ANY OTHER WIRELESS MOBILE DEVICES
What I claim as my invention is: WAP Shopping Site with catalog System that allows for the displaying, browsing, and searching of products with WAP shopping cart that allows visitors to add, view, and delete items ordered and allows visitors to check out, when visitors check out they are presented with a secure page to supply their personal information with built in 24 Hour a Day, 7 Days a Week Support System providing customers with feedbacks and communications, using database like Access Database, SQL Server, Oracle Server etc.

4 E-COMMERCE SOLUTION FOR WIRELESS MOBILE PHONE AND ANY OTHER WIRELESS MOBILE DEVICES
What I claim as my invention is: WAP Shopping Site with catalog System that allows for the displaying, browsing, and searching of products with WAP shopping cart that allows visitors to add, view, and delete items ordered and allows visitors to check out, when visitors check out they are presented with a secure page to supply their personal information with built in 24 Hour a Day, 7 Days a Week Support System providing customers with feedbacks and communications, using database like Access Database, SQL Server, Oracle Server etc, and customers are also able to shop online on this shopping site using their computers.
